(19) United States
(12) Patent Application Publication
(10) Pub. No.: US 2005/0120191 A1
(43) Pub. Date: Jun. 2, 2005

(54) Checkpoint-based register reclamation

(75) Inventors: Haitham H. Akkary, Portland, OR (US); Ravi Rajwar, Portland, OR (US); Srikanth T. Srinivasan, Portland, OR (US)

Correspondence Address: VENABLE, BAETJER, HOWARD AND CIVILETTI, LLP, P.O. BOX 34385, WASHINGTON, DC, 20043-9998, US

(73) Assignee: Intel Corporation (a Delaware corporation), Santa Clara, CA (US)

(21) Appl. No.: 10/724,874

(22) Filed: Dec. 2, 2003

(51) Int. Cl. G06F 9/30

(52) U.S. Cl. 712/217; 712/228

(57) ABSTRACT

A processor enabled with checkpoints may be used to recover registers using counter entry and release.

### BACKGROUND OF THE INVENTION

Some embodiments of the present invention are generally related to microprocessors, and more particularly, to microprocessors with physical registers.

Modern microprocessors may achieve high frequencies by exposing instruction level parallelism (ILP) by concurrently operating upon a large number of instructions, also known as an instruction window.

Large instruction windows may require large physical register files. The physical register file may be used to increase ILP by renaming logical registers, and removing write-after-write and write-after-read dependencies. The physical register may be allocated at the time the corresponding instruction is renamed, and may be released when a subsequent instruction that overwrites the physical register's corresponding logical register is retired.

Thus, the lifetime of a physical register may exceed the lifetime of its allocating instruction. As most instructions have a destination register operand, the register file size may scale with the instruction window size. Furthermore, the physical register may be a highly ported structure. Both of these factors may introduce complexity and increase cycle time.

### BRIEF DESCRIPTION OF THE DRAWINGS

The invention shall be described with reference to the accompanying figures, wherein:

FIG. 1 illustrates a diagram of a physical register file, according to an embodiment of the present invention;

FIG. 2 illustrates a diagram of portions of a pipeline in a processor for using checkpoints, according to an embodiment of the present invention;

FIG. 3 illustrates a diagram of portions of a pipeline in a processor for using checkpoints with a recovery buffer, according to an embodiment of the present invention;

FIG. 4 illustrates a diagram of a checkpoint buffer, according to an embodiment of the present invention;

FIGS. 5-6 illustrate flow diagrams of physical register reclamation, according to embodiments of the present invention;

FIGS. 7-8 illustrates diagrams of system environments capable of performing the operations of physical register reclamation, according to embodiments of the present invention; and

FIG. 9 illustrates a diagram of a computing environment capable of being performing the operations of physical register reclamation, according to an embodiment of the present invention.

The invention is now described with reference to the accompanying drawings. In the drawings, like reference numbers generally indicate identical, functionally similar, and/or structurally similar elements. The drawing in which an element first appears is generally indicated by the left-most digit(s) in the corresponding reference number.

### DETAILED DESCRIPTION OF PREFERRED EMBODIMENTS

While the present invention is described in terms of the examples below, this is for convenience only and is not intended to limit its application. In fact, after reading the following description, it will be apparent to one of ordinary skill in the art how to implement the following invention in alternative embodiments (e.g., reclaiming physical registers in a processor able to restore the architecturally correct register state without checkpoints).

Furthermore, while the following description focuses on the recovery of instructions in a microprocessor using a form of an Itanium® Processor Family (IPF) compatible processor or in a Pentium® compatible processor family (both manufactured by Intel® Corporation, Santa Clara, Calif.), it is not intended to limit the application of the present invention. It will be apparent to one skilled in the relevant art how to implement the following invention, where appropriate, in alternative embodiments. For example, the present invention may be applied, alone or in combination, with various microprocessor architectures and their inherent features, such as, but not limited to, complex instruction set (CISC), reduced instruction set (RISC), very long instruction word (VLIW), and explicitly parallel instruction computing (EPIC).

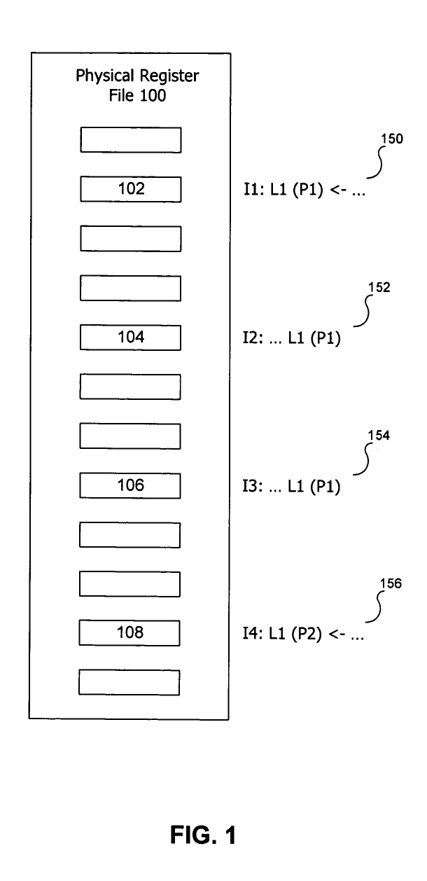

With respect to FIG. 1, a diagram of physical register use in a program is shown, according to an embodiment of the present invention. In this diagram, blocks, such as blocks 102-108, may represent individual registers or groups of registers. Additionally, instructions (I#), logical registers (L#), and specific physical register (P#) may be indicated, such as by elements 150-156.

By using checkpoints of architectural register states, which may be created at selected points, a means of implementing large instruction window processors may be provided. Rather than build and maintain large physical register files, the embodiments of the present invention may teach the use of checkpoints to track whenever an instruction that uses the physical register as an input operand is renamed. Furthermore, the embodiments of the present invention may teach the use of checkpoints to track whenever an instruction is issued and/or reads the physical register. In accordance with the embodiments of the present invention, the physical register may be freed and reclaimed when a counter value, maintained by the checkpoint, for the physical register reaches a value that is predetermined. In one embodiment, the predetermined value is equivalent to the starting value and may coincide with when the logical register that is mapped to the physical register is renamed again, that is, when the physical register is unmapped. According to one embodiment of the present invention, the processor tracks whether a physical register has been unmapped or not with the use of an unmapped flag that is associated with the physical register.

FIG. 1 shows a diagram of register definition and use, according to embodiments of the present invention. In this diagram, a logical register (L1) at 150 is defined by instruction (I1). I1, as shown, is mapped to physical register P1, but other mappings are possible as one of ordinary skill in the art would recognized, based at least on the teachings described herein. Physical register P1 may be any of the registers within the physical register 100, such as, but not limited to one or more of registers 102, 104, 106, and 108. The logical register L1 may be used by instructions I2 and I3 before being re-mapped to physical register P2 by instruction I4, as indicated by elements 152, 154, and 156. In one implementation of a register reclamation scheme, physical register P1 may be released when instruction I4 retires. However, according to embodiments of the present invention, physical register P1 may be released after P1 is unmapped, that is once logical register L1 is re-mapped to physical register P2, when instruction L4 is allocated in element 156. This may happen immediately subsequent to instructions I2 and I3 reading physical register P1 at elements 152 and 154. Subsequent processing may occur further within the physical register file 100.

According to an embodiment of the present invention, a processor with checkpoints may reclaim registers that are associated with the checkpoints. The above-described embodiments, described with regard to FIG. 1, are now further described with respect to a processor with checkpoints. Physical registers mapped to logical registers at the time of checkpoint creation may be said to be associated with (or belonging to) that checkpoint. Since a checkpoint provides the ability to restore the architecturally correct register state, that is, the state at the time of checkpoint creation, physical registers that may be associated with a checkpoint may not be released until the checkpoint is released. In one embodiment, this may be accomplished by making each checkpoint a reader of all the physical registers associated with it.

Hence, in one embodiment, when a checkpoint is created, the counters, which may be, but are not limited to read counters, as described in various embodiments herein, for all physical registers associated with the checkpoint may be incremented. In another embodiment, when the checkpoint is released, the counters for all physical registers associated with the checkpoint may be decremented. The application of this counter mechanism may guarantee the physical registers are not released until the associated checkpoint is released. In a processor using checkpoints, according to embodiments of the present invention, the processor may prevent physical registers associated with one of the checkpoints from being accidentally released after being unmapped by incorrectly speculated or mispredicted instructions using the unmapped flags that may be part of the checkpoint. This embodiment may preserve the unmapped flags with the architectural state as it was at the time that the checkpoint was created. Thus, even if an incorrectly speculated or mispredicted instruction unmaps a physical register, a checkpoint recovery may result in these flags being restored to their correct values prior to a fault, error, and/or branch misprediction.

According to one embodiment of the present invention, the checkpoint-based register reclamation mechanisms may enable precise interrupts/exceptions to be implemented and proper recovery from branch mispredictions in a processor with checkpoints. The mechanism may accomplish this, as described herein, by not releasing physical registers associated with a checkpoint before the checkpoint is released; making the unmapped flags part of the checkpoint; and letting all incorrectly speculated instructions decrement any counters that they had previously incremented.

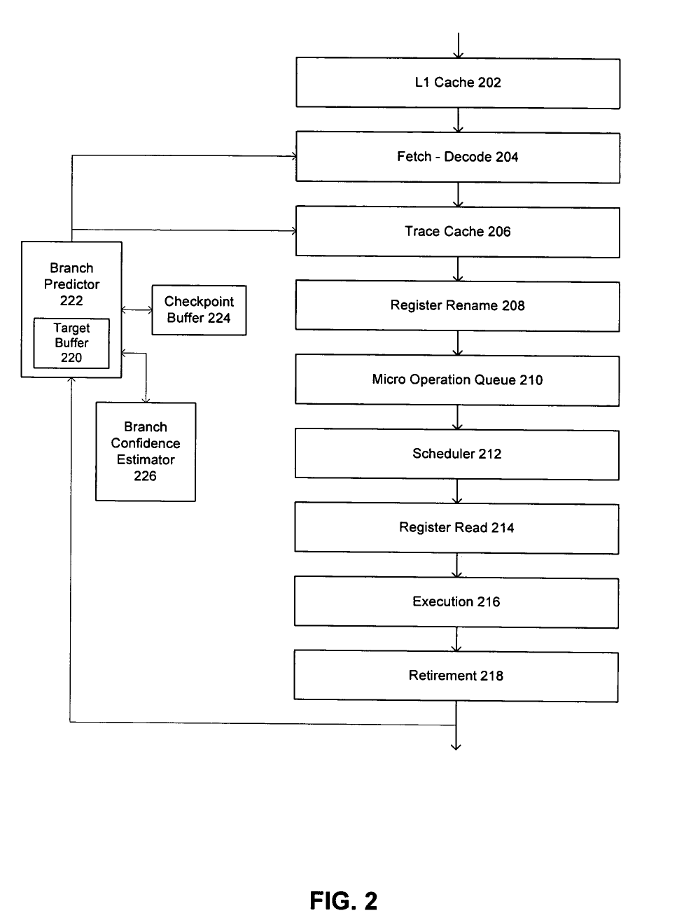

Referring to FIG. 2, a diagram of portions of a pipeline in a processor for checkpoint-based register reclamation is shown, according to an embodiment of the present invention. A L1 cache 202 may store instructions which may be fetched and decoded by a fetch-decode stage 204. Decoded instructions may be stored in a trace cache 206 or other form of instruction buffer. These instructions may have their operand logical registers mapped to operand physical registers in a register rename stage 208. The decoded and register-renamed instructions may be stored in a micro-operation queue 210 before being scheduled for execution in a scheduler stage 212. Once scheduled for execution, the instructions may read the operand registers in register read stage 214 before being executed in one or more execution units 216. If exceptions are not raised in the retirement stage 218, then the results of the execution may be used to update the machine state, which may include writing results to destination operand registers.

A branch target buffer (BTB) 220 and branch predictor 222 may be used to issue branch predictions to the fetch-decode stage 204 or, in some embodiments, to the trace cache 206. The branch prediction may take the form of a predicted target address stored in the BTB 220. According to an embodiment of the present invention, the branch prediction may also be provided with an estimate of the misprediction probability of the branch by a branch confidence estimator 226.

According to embodiments of the present invention, the use of checkpoints to maintain counters that track physical register usage may provide register reclamation. In one embodiment, all of the physical registers may be read by one or more of the checkpoints. When an instruction is fetched, it may be tracked. In other embodiments, any instruction may be assigned a checkpoint and counter information about each checkpoint stored in a checkpoint buffer 224.

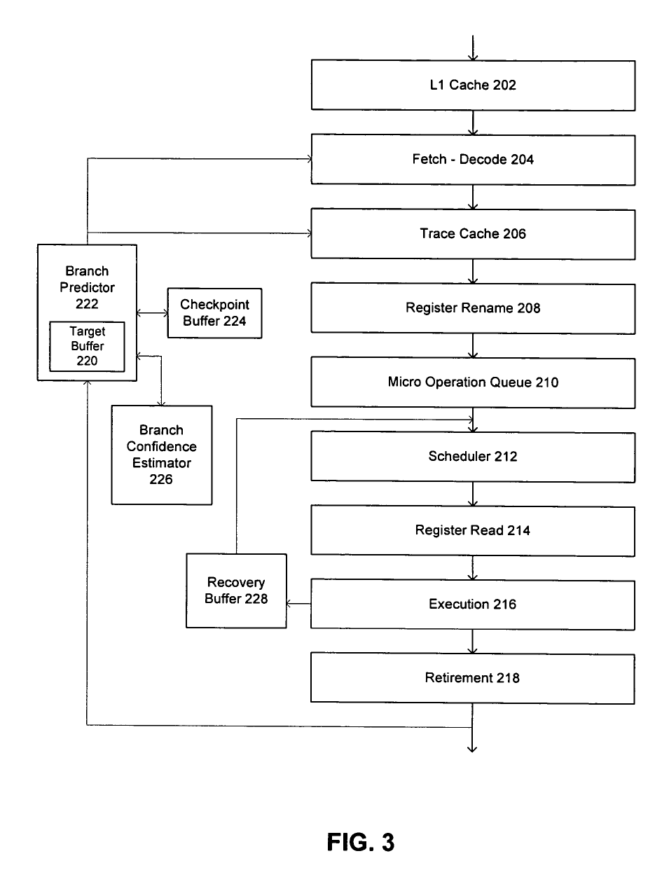

Alternatively, as the diagram of FIG. 3 illustrates, a recovery buffer 228 may be used to store previously executed instructions for possible use in selective recovery operations. In any of these embodiments, the checkpoints may be also used to support selective recovery of the entire architectural state of the processor.

A processor using checkpoints, according to embodiments of the present invention, provides a non-serial approach that may allow for scalable renaming operations. Processor performance may be negatively affected by the placement of checkpoints at every single branch. Thus, the number of rename map table checkpoints or simply checkpoints may be carefully limited to selective points, preferably at branches having a high misprediction probability. The restoring of counter information associated with the physical registers may provide the processor with the ability to directly reclaim registers in use by instructions in the mispredicted branch.

The misprediction probability of a given branch may be determined with the use of a branch confidence estimator (BCE), such as the BCE 226 described above with respect to FIG. 2.

According to one embodiment of the present invention, on a branch misprediction, execution may restart from the nearest checkpoint prior to the mispredicted branch. If the checkpoint is not at the mispredicted branch, good instructions between the checkpointed instruction and the mispredicted branch may need to be re-executed. To minimize this overhead, which may also be called checkpoint overhead, the BCE may cover a large fraction of mispredicted branches. In one embodiment, the branch predictor may use a table of 4-bit saturating counters indexed using an XOR of the branch address and the global branch history. According to this embodiment, the counters may be reset to zero when the corresponding branch is mispredicted and incremented on a correct branch prediction. A branch with a high counter value may be predicted as high confidence, and other branches may be predicted as low confidence. This application may provide a maximum set of checkpoints from which the branch predictor may further determine confidence levels of branches, and may determine which branches are associated with checkpoints.

The checkpoint buffer, such as checkpoint buffer 224, may keep track of rename map table checkpoints. Each checkpoint may correspond to a very large number of instructions, and their numbers may vary across checkpoints. In one example, a checkpoint entry may correspond to 300 instructions and thus eight checkpoints may be sufficient to support 2048 instructions.

According to embodiments of the present invention, checkpoint allocation and reclamation may occur in a first-in-first-out order. A checkpoint may be allocated only if a free checkpoint is available, and each checkpoint buffer entry may have a counter to determine when the corresponding allocated checkpoint can be freed. The counter may track completion of instructions associated with the checkpoint, that is, the counter may be incremented when an instruction is allocated and decremented when the instruction completes execution. Counter overflow may be prevented by forcing a new checkpoint. If the checkpoint buffer is full, an instruction may be stalled until a checkpoint is freed. The oldest checkpoint may be reclaimed when its associated counter has a value which indicates that the instructions associated with the checkpoint, through the logical registers to the physical registers via the counter, have completed execution, for example, a counter value of zero. Prior to a physical register being reclaimed or retired, the checkpoint associated with it may be retired and a new checkpoint, associated to the now current instruction(s), generated to ensure that there is always forward progress in the processor and that there is always at least one checkpoint to which to return in the event of an exception, branch misprediction, or other fault.

Each instruction may have an identifier associating it to a specific checkpoint. Instructions may use this identifier to access the appropriate checkpoint buffer for incrementing and decrementing the counter. This identifier may also be used to select instruction to be squashed or committed. As soon as the last instruction belonging to a checkpoint completes, all instructions in that checkpoint may be retired instantly and the associated checkpoint may be reclaimed. This may provide the ability to commit hundreds of instructions instantly, thereby potentially removing the in-order and serial retirement constraints enforced by a re-order buffer (ROB).

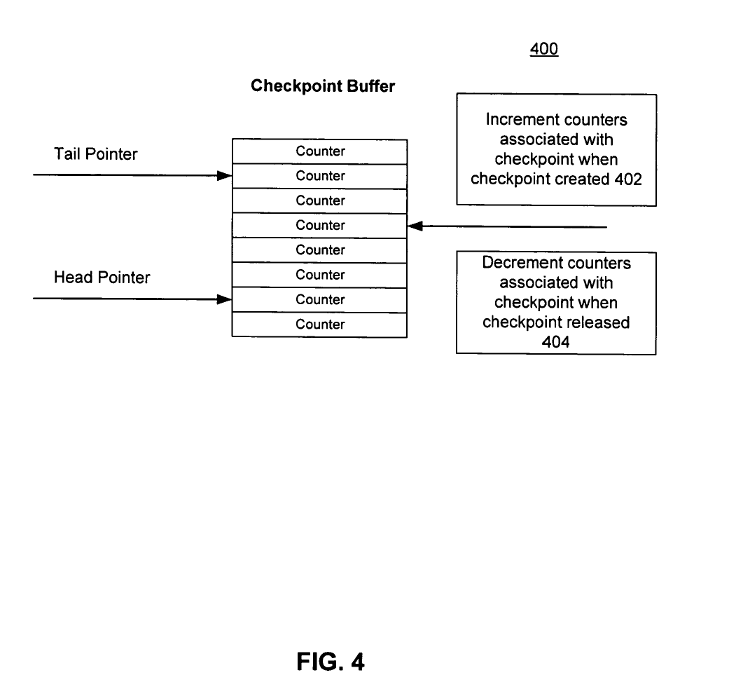

FIG. 4 illustrates a diagram of the checkpoint buffer 400, according to an embodiment of the present invention. As described in more detail below, when instructions are dispatched, one or more counters within the checkpoint buffer 400 may be incremented, as indicated by block 402. Furthermore, when instructions are completed, one or more counters within the checkpoint buffer 400 may be decremented, as indicated by block 404. Specific embodiments of the present invention discuss implementations of the checkpoint buffer herein, but the present invention is not limited to these specific implementations. One of ordinary skilled in the art would recognize that other type of configurations could be used to perform the functionality of the checkpoint buffer, based on at least from the teachings described herein.

While a checkpoint may be placed at low confidence branches, other branches within the checkpoint may be mispredicted, forcing a recovery to a prior checkpoint. To prevent the same branches from being repeatedly mispredicted, on a re-execution from a checkpoint, the branch outcome from the previously aborted execution may be used rather than a prediction. This may, in one embodiment, be done by storing the branch distance (in number of branches) from the checkpoint and the associated branch outcome. This outcome may be used on a restart thus preventing repeated mispredictions. A checkpoint may include any number of instructions, including a single instruction. Thus, forward progress may always be guaranteed, even under pathological cases, by forcing a checkpoint right after the instruction at the head of the instruction window and thus allowing the instruction at the head of the window to commit. This is exactly the same forward progress solution used in a ROB-based architecture in which the head of the ROB is always allowed to commit, even in the presence of external events such as snoop invalidations in multiprocessors.

According to embodiments of the present invention, rather than using the ROB for branch recovery, the checkpoint buffer may be used for performing recovery. The size of the instruction window may not be limited by the rename map table checkpoints size because checkpoints may be created infrequently at low confidence branch points in the instruction window or when necessary, such as at architecture-specific serializing instructions.

The embodiments of the present invention may replace the ROB-based designs with a micro-architecture which may use confidence-based checkpoints and checkpoint counters for branch recovery, where each checkpoint corresponds to a group of instructions. A branch misprediction may result in a rollback to the closest checkpoint. The embodiments described herein may perform register reclamation using counters, thereby decoupling register reclamation from the in-order instruction commit semantics provided by the ROB. Additionally, the checkpoints may also be used for recovering from faults and in providing precise interrupts.

The checkpoint based architecture may use numerous counters. Counters may be used for tracking allocated instructions, for reclaiming registers, for counters in store queues. The present invention may ease counter management by allowing all instructions to eventually decrement the counters, including squashed instructions that are merely draining out of the pipeline. In one embodiment, a counter's associated resources may be released only when a counter reaches zero. For example, if an instruction is squashed due to a branch misprediction, the instruction may still decrement any related counters even as it is draining out of the pipeline without affecting any other architectural state, thereby freeing any associated physical registers prior to the retirement of the subsequent instructions, such as, but not limited to, instruction I4 in FIG. 1. Thus, no global reset signals may be required for counters in the various structures.

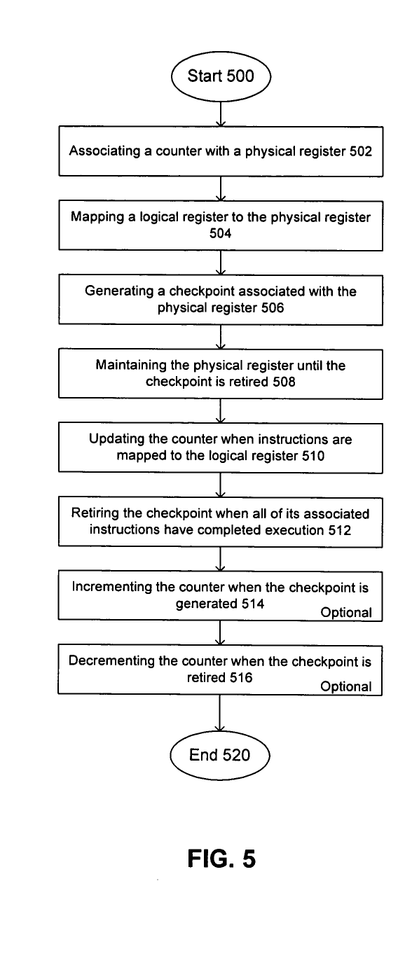

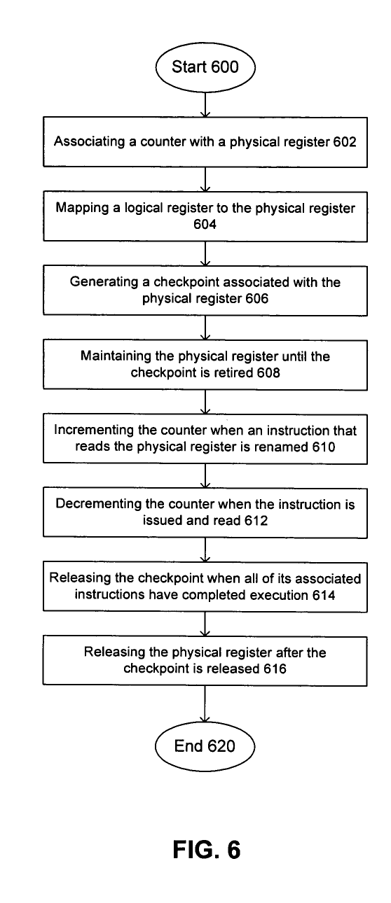

In accordance with the above-described embodiments, the present invention is now illustrated with respect to FIGS. 5-6. As discussed herein, a processor enabled with checkpoints, which may be implemented with, inter alia, the branch predictor 222, branch confidence estimator 226, and checkpoint buffer 224, may manage the reclamation of physical registers in accordance with the exemplary methods discussed below.

Regarding FIG. 5, a flow diagram of physical register reclamation, according to an embodiment of the present invention, is shown. At step 500, the process starts and process to associating at least one counter with at least one physical register in step 502. A processor, as described above, may employ a circuit which includes, but is not limited to, the elements of FIGS. 2-4, to make the association between the counter and the physical register. The process continues to step 504, where it proceeds to mapping a logical register to the physical register. The logical register may be defined by one or more instructions, which according to embodiments flow into portions of the pipeline described above. The process continues to step 506 by generating a checkpoint, where the checkpoint is associated with the physical register. Another circuit, now including the checkpoint buffer 224, may now be included to generate the checkpoint and to continue to step 508 where, according to one embodiment of the present invention, the physical register may be maintained until the checkpoint is retired. The process proceeds to step 510 by updating the counter when one or more instructions are mapped to the logical register. The updating of the counters may be contingent upon whether the instructions are being created or completing. In one embodiment, the updating of the counters may include incrementing the counters, as optionally performed in step 514. The process proceeds in step 512 to retiring the checkpoint when all of its associated instructions have completed execution.

Optionally, the updating of step 510 may include where the counter may be incremented when an instruction of the logical register, using the physical register as an input operand, is renamed. This possibility is illustrated in step 514. Furthermore, the updating of step 510 may include where the counter may be decremented when the instruction is issued and reads the physical register. This possibility is illustrated in step 516.

In alternative embodiments, the process step 512 may include the releasing of the checkpoint when the counter is decremented, wherein the decrementing reaches a state indicating that all associated instructions have read the physical register. Furthermore, the process step 512 may be predicated upon the releasing of the physical register only after the associated checkpoint is released.

In embodiments of the present invention, as described above with respect to the use of an unmapped flag. Each checkpoint may include at least one unmapped flag for each of the physical registers associated with the checkpoint. In additional embodiments, the counter may be incremented when said checkpoint is generated and decremented when said checkpoint is retired, as one of ordinary skill in the art would comprehend, based at least on the teachings described herein.

In FIG. 6, a flow diagram of physical register reclamation, according to another embodiment of the present invention, is shown. At step 600, the process starts and process to associating at least one counter with at least one physical register in step 602. A processor, as described above, may employ a circuit which includes, but is not limited to, the elements of FIGS. 2-4, to make the association between the counter and the physical register. The process continues to step 604, where it proceeds to mapping a logical register to the physical register. The logical register may be defined by one or more instructions, which according to embodiments flow into portions of the pipeline described above. The process continues to step 606 by generating a checkpoint, where the checkpoint is associated with the physical register. Another circuit, now including the checkpoint buffer 224, may now be included to generate the checkpoint and to continue to step 608 where, according to one embodiment of the present invention, the physical register may be maintained until the checkpoint is retired. The process proceeds to step 610 by incrementing the counter when an instruction is renamed. The process proceeds to step 612 by decrementing the counter when the instruction is issued and read. The incrementing and decrementing of the counters may be contingent upon whether the instructions are being created or completing. The process proceeds in step 614 to releasing the checkpoint when all of its associated instructions have completed execution. In one embodiment, when all of its associated instructions have completed execution, the counter may have a value of zero, or it may be whatever initial value was given to the counter. Thus, the decrementing of the counter may provide in indication that all of the instructions associated with the checkpoint have completed execution. Regardless, the process may proceed to release the checkpoint based upon the meeting of the condition. In step 616, the physical register is released after the checkpoint is released in step 614. The release of the physical register at this point reclaims the physical register for other uses prior to the retirement of the instruction that remapped from that physical register to one or more other physical registers.

In this detailed description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In this detailed description and claims, the term “coupled,” along with its derivatives, may be used. It should be understood that “coupled” may mean that two or more elements are in direct physical or electrical contact with each other or that the two or more elements are not in direct contact but still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

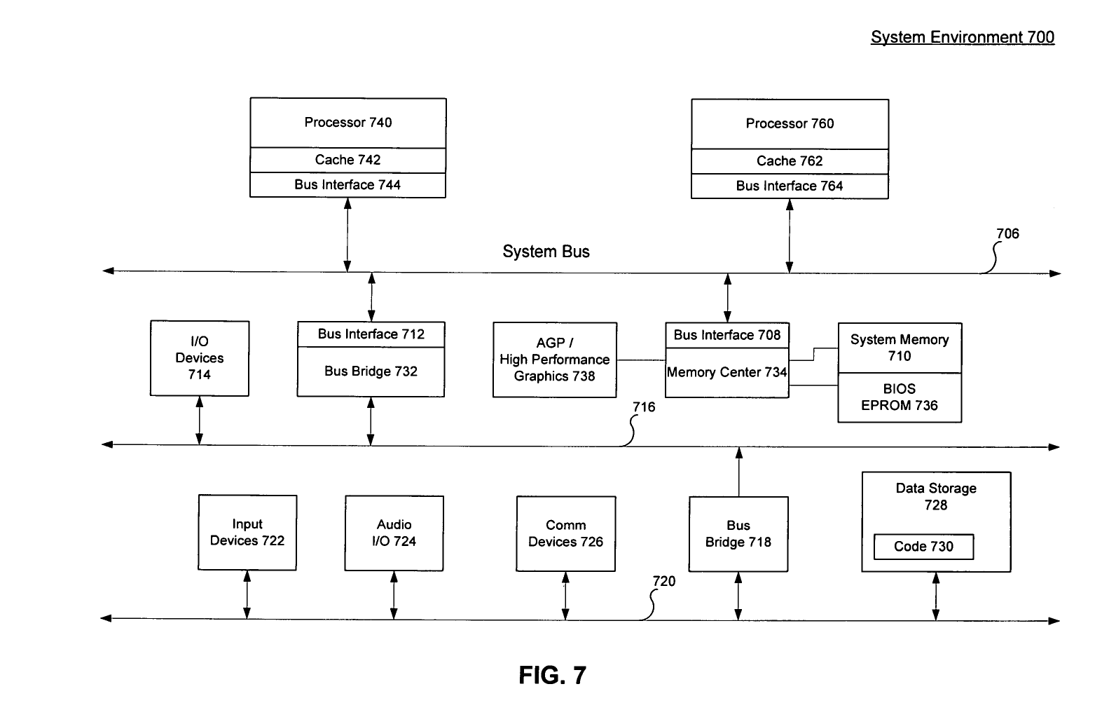

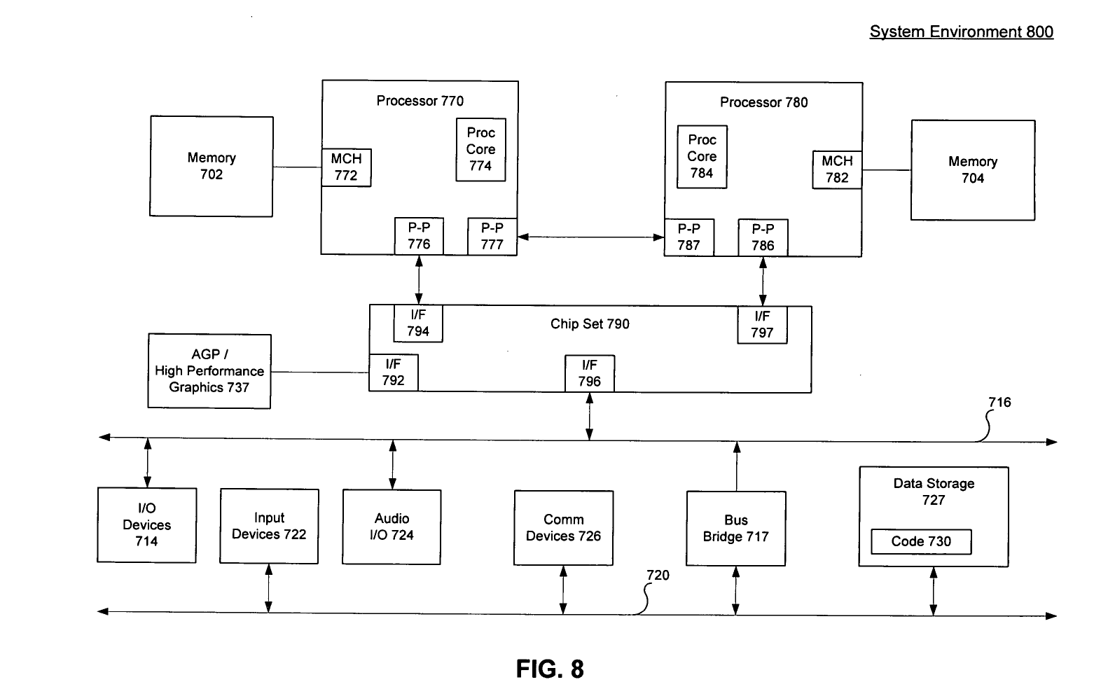

Specifically, and only by way of example, the present invention (i.e., the processes of FIGS. 5-6 and the components of FIGS. 2-4 or any part thereof) may be implemented using one or more microprocessor architectures or a combination thereof and may be implemented with one or more memory hierarchies. In fact, in one embodiment, the invention may be directed toward one or more processor environments capable of carrying out the functionality described herein. An example of system environments 700 and 800 are shown in FIGS. 7 and 8 and include one or more central processing units, memory units, and buses. The system environments 700 and 800 may include a core logic system chip set that connects a microprocessor to a computing system. Various microprocessor architecture embodiments are described in terms of these exemplary micro-processing and system environments. After reading this description, it will become apparent to a person of ordinary skill in the art how to implement the invention using other micro-processing and/or system environments, based at least on the teachings provided herein.

Referring now to FIGS. 7 and 8, schematic diagrams of systems including a processor supporting execution of speculative threads are shown, according to two embodiments of the present invention. The system environment 700 generally shows a system where processors, memory, and input/output devices may be interconnected by a system bus, whereas the system environment 800 generally shows a system where processors, memory, and input/output devices may be interconnected by a number of point-to-point interfaces.

The system environment 700 may include several processors, of which only two, processors 740, 760 are shown for clarity. Processors 740, 760 may include level one (L1) caches 742, 762. The system environment 700 may have several functions connected via bus interfaces 744, 764, 712, 708 with a system bus 706. In one embodiment, system bus 706 may be the front side bus (FSB) utilized with Pentium® class microprocessors. In other embodiments, other busses may be used. In some embodiments memory controller 734 and bus bridge 732 may collectively be referred to as a chip set. In some embodiments, functions of a chipset may be divided among physical chips differently from the manner shown in the system environment 700.

Memory controller 734 may permit processors 740, 760 to read and write from system memory 710 and/or from a basic input/output system (BIOS) erasable programmable read-only memory (EPROM) 736. In some embodiments BIOS EPROM 736 may utilize flash memory. Memory controller 734 may include a bus interface 708 to permit memory read and write data to be carried to and from bus agents on system bus 706. Memory controller 734 may also connect with a high-performance graphics circuit 738 across a high-performance graphics interface 739. In certain embodiments the high-performance graphics interface 739 may be an advanced graphics port (AGP) interface. Memory controller 734 may direct read data from system memory 710 to the high-performance graphics circuit 738 across high-performance graphics interface 739.

The system environment 800 may also include several processors, of which only two, processors 770, 780 are shown for clarity. Processors 770, 780 may each include a local memory channel hub (MCH) 772, 782 to connect with memory 702, 704. Processors 770, 780 may exchange data via a point-to-point interface 750 using point-to-point interface circuits 778, 788. Processors 770, 780 may each exchange data with a chipset 790 via individual point-to-point interfaces 752, 754 using point to point interface circuits 776, 794, 786, 798. Chipset 790 may also exchange data with a high-performance graphics circuit 738 via a high-performance graphics interface 792.

In the system environment 700, bus bridge 732 may permit data exchanges between system bus 706 and bus 716, which may in some embodiments be a industry standard architecture (ISA) bus or a peripheral component interconnect (PCI) bus. In the system environment 800, chipset 790 may exchange data with a bus 716 via a bus interface 796. In either system, there may be various input/output I/O devices 714 on the bus 716, including in some embodiments low performance graphics controllers, video controllers, and networking controllers. Another bus bridge 718 may in some embodiments be used to permit data exchanges between bus 716 and bus 720. Bus 720 may in some embodiments be a small computer system interface (SCSI) bus, integrated drive electronics (IDE) bus, or universal serial bus (USB) bus. Additional I/O devices may be connected with bus 720. These may include input devices 722, which may include, but are not limited to, keyboards, pointing devices, and mice, audio I/O 724, communications devices 726, including modems and network interfaces, and data storage devices 728. Software code 730 may be stored on data storage device 728. In some embodiments, data storage device 728 may be, for example, but is not limited to, a fixed magnetic disk, a floppy disk drive, an optical disk drive, a magneto-optical disk drive, a magnetic tape, or non-volatile memory including flash memory.

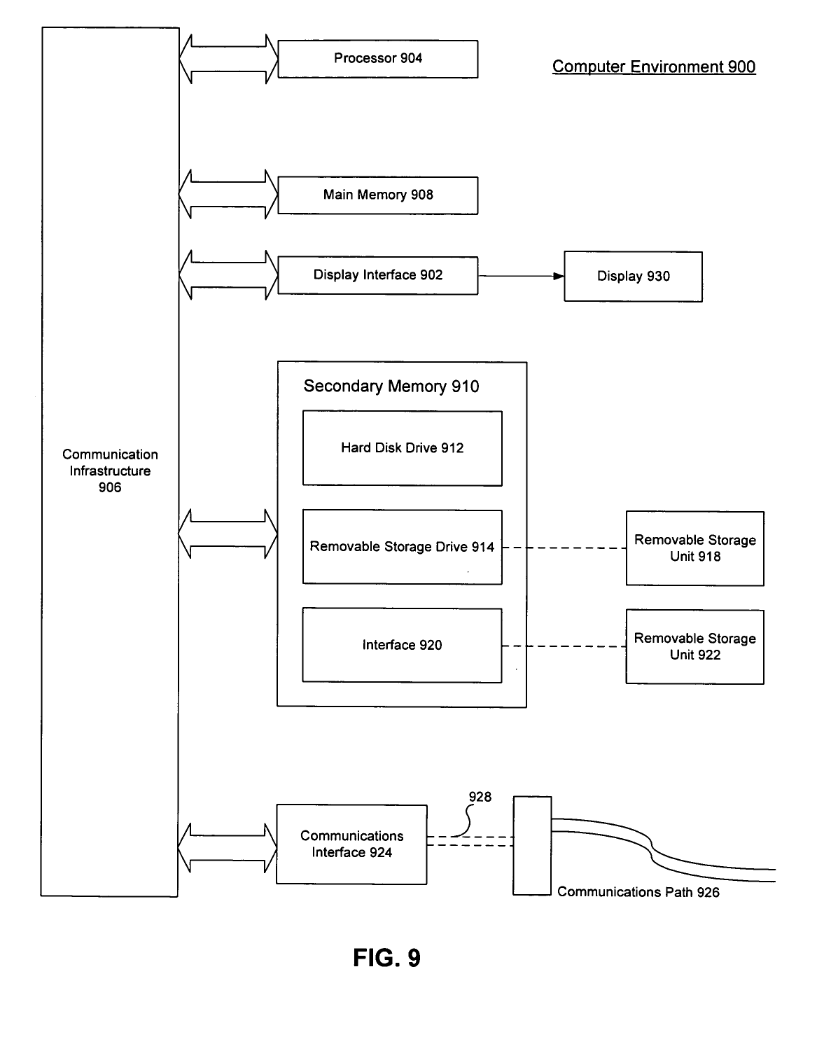

The present invention (i.e., the physical register reclamation system or any part thereof) may be implemented using hardware, software or a combination thereof and may be implemented in one or more computer systems or other processing systems. In fact, in one embodiment, the invention may comprise one or more computer systems capable of carrying out the functionality described herein. An example of a computer system 900 is shown in FIG. 9. The computer system 900 may include one or more processors, such as processor 904. The processor 904 may be connected to a communication infrastructure 906 (e.g., a communications bus, cross over bar, or network). Various software embodiments are described in terms of this exemplary computer system. After reading this description, it will become apparent to a person skilled in the relevant art(s) how to implement the invention using other computer systems and/or computer architectures.

Computer system 900 may include a display interface 902 that may forward graphics, text, and other data from the communication infrastructure 906 (or from a frame buffer not shown) for display on the display unit 930.

Computer system 900 may also include a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc, but which is not limited thereto. The removable storage drive 914 may read from and/or write to a removable storage unit 918 in a well known manner. Removable storage unit 918, may represent a floppy disk, magnetic tape, optical disk, etc. which may be read by and written to by removable storage drive 914. As will be appreciated, the removable storage unit 918 may include a computer usable storage medium having stored therein computer software and/or data.

In alternative embodiments, secondary memory 910 may include other similar means for allowing computer programs or other instructions to be loaded into computer system 900. Such means may include, for example, a removable storage unit 922 and an interface 920. Examples of such may include, but are not limited to, a program cartridge and cartridge interface (such as that found in video game devices), a removable memory chip (such as an EPROM, or PROM) and associated socket, and/or other removable storage units 922 and interfaces 920 that may allow software and data to be transferred from the removable storage unit 922 to computer system 900.

Computer system 900 may also include a communications interface 924. Communications interface 924 may allow software and data to be transferred between computer system 900 and external devices. Examples of communications interface 924 may include, but are not limited to, a modem, a network interface (such as an Ethernet card), a communications port, a PCMCIA slot and card, etc. Software and data transferred via communications interface 924 are in the form of signals 928 which may be, for example, electronic, electromagnetic, optical or other signals capable of being received by communications interface 924. These signals 928 may be provided to communications interface 924 via a communications path (i.e., channel) 926. This channel 926 may carry signals 928 and may be implemented using wire or cable, fiber optics, a phone line, a cellular phone link, an RF link and/or other communications channels.

In this document, the terms “computer program medium” and “computer usable medium” are used to generally refer to media such as, but not limited to, removable storage drive 914, a hard disk installed in hard disk drive 912, and signals 928. These computer program media are means for providing software to computer system 900.

Computer programs (also called computer control logic) may be stored in main memory 908 and/or secondary memory 910. Computer programs may also be received via communications interface 924. Such computer programs, when executed, enable the computer system 900 to perform the features of the present invention as discussed herein. In particular, the computer programs, when executed, may enable the processor 904 to perform the present invention in accordance with the above-described embodiments. Accordingly, such computer programs represent controllers of the computer system 900.

In an embodiment where the invention is implemented using software, the software may be stored in a computer program product and loaded into computer system 900 using, for example, removable storage drive 914, hard drive 912 or communications interface 924. The control logic (software), when executed by the processor 904, causes the processor 904 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). As discussed above, the invention is implemented using any combination of hardware, firmware and software.

While various embodiments of the invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus the invention should not be limited by any of the above described exemplary embodiments, but should be defined only in accordance with the following claims and their equivalents.

1. A method, comprising:
generating a checkpoint, wherein said checkpoint is associated with at least one physical register, and wherein said at least one physical register is associated with at least one counter;
maintaining said at least one physical register until said checkpoint is retired, wherein said at least one physical register is mapped to a logical register;
updating said at least one counter when one or more instructions are mapped to said logical register;
retiring said checkpoint when all of said one or more instructions associated with said checkpoint have completely executed; and
releasing said at least one physical register associated with said checkpoint.

2. The method of claim 1, said updating said at least one counter further comprising:
incrementing said at least one counter when at least one instruction with said logical register as an input operand is renamed to said at least one physical register.

3. The method of claim 2, said updating said at least one counter further comprising:
decrementing said at least one counter when said instruction is issued and reads said at least one physical register.

4. The method of claim 1, said releasing said at least one physical register further comprising:
releasing said at least one physical register when said counter is decremented, wherein said decrementing reaches a state indicating that none of said instructions have yet to read said at least one physical register.

5. The method of claim 4, said releasing said at least one physical register further comprising:
releasing said at least one physical register only after said associated checkpoint is released.

6. The method of claim 1, wherein said checkpoint includes at least one unmapped flag for each of said at least one physical register associated with said checkpoint.

7. The method of claim 1, wherein said at least one counter is incremented when said checkpoint is generated.

8. The method of claim 1, wherein said at least one counter is decremented when said checkpoint is retired.

9. An apparatus, comprising:
a branch predictor to generate a checkpoint, wherein said checkpoint is associated with at least one physical register;
a checkpoint buffer to maintain said at least one physical register, said at least one physical register associated with one or more instructions;
wherein said branch predictor retires said checkpoint when all of said one or more instructions have completely executed and releases said at least one physical register associated with said checkpoint.

10. The apparatus of claim 9, wherein said checkpoint buffer increments at least one counter when said checkpoint is generated; wherein said at least one counter is associated with said at least one physical register.

11. The apparatus of claim 9, wherein said checkpoint buffer decrements at least one counter when said checkpoint is retired, wherein said at least one counter is associated with said at least one physical register.

12. The apparatus of claim 9, wherein said branch predictor increments at least one counter when at least one of said one or more instructions with a logical register as an input operand is renamed to said at least one physical register.

13. The apparatus of claim 9, wherein said branch predictor decrements at least one counter when at least one of said one or more instructions is issued and reads said at least one physical register.

14. The apparatus of claim 9, wherein said branch predictor releases said at least one physical register when at least one counter is decremented to a state indicating that none of said one or more instructions have yet to read said at least one physical register.

15. The apparatus of claim 14, wherein said branch predictor releases said at least one physical register after said checkpoint is released.

16. The apparatus of claim 9, wherein said checkpoint includes at least one unmapped flag for each of said at least one physical registers associated with said checkpoint.

17. A system, comprising:
a processor including a branch predictor to a branch predictor to generate a checkpoint, wherein said checkpoint is associated with at least one physical register, a checkpoint buffer to maintain said at least one physical register, said at least one physical register associated with one or more instructions, wherein said branch predictor retires said checkpoint when all of said one or more instructions have completely executed and releases said at least one physical register associated with said checkpoint;
an interface to couple said processor to input-output devices; and
a data storage coupled to said interface to receive code from said processor.

18. The system of claim 17, wherein said checkpoint buffer increments at least one counter when said checkpoint is generated; wherein said at least one counter is associated with said at least one physical register.

19. The system of claim 17, wherein said checkpoint buffer decrements at least one counter when said checkpoint is retired, wherein said at least one counter is associated with said at least one physical register.

20. The system of claim 17, wherein said branch predictor increments at least one counter when at least one of said one or more instructions with a logical register as an input operand is renamed to said at least one physical register.

21. The system of claim 17, wherein said branch predictor decrements at least one counter when at least one of said one or more instructions is issued and reads said at least one physical register.

22. The system of claim 17, wherein said branch predictor releases said at least one physical register when at least one counter is decremented to a state indicating that none of said one or more instructions have yet to read said at least one physical register.

23. The system of claim 22, wherein said branch predictor releases said at least one physical register after said checkpoint is released.

24. The system of claim 17, wherein said checkpoint includes at least one unmapped flag for each of said at least one physical registers associated with said checkpoint.
